(19) United States
(12) Patent Application Publication
(10) Pub. No.: US 2006/0041657 A1
(43) Pub. Date: Feb. 23, 2006

(54) Method and apparatus for managing business cell phone usage

(76) Inventors: Chih-Po Wen, Redwood City, CA (US); Charles L. Marker II, Los Altos Hills, CA (US); Constantin S. Delivanis, Los Altos Hills, CA (US); Arvind Sharma, Menlo Park, CA (US)

Correspondence Address: RONALD CRAIG FISH;RONALD CRAIG FISH, A LAW CORPORATION, 202 PALMER DRIVE, LOS GATOS, CA, 95032, US

(21) Appl. No.: 10/920,712

(22) Filed: Aug. 17, 2004

(51) Int. Cl. G06F 15/173

(52) U.S. Cl. 709/224

(57) ABSTRACT

A process and apparatus to remotely gather data about cellphone hardware and software configurations and usage. The system uses agents which are resident on the phones and which can be remotely launched by a data collection server by sending a message to a public P address of the phone and addressed to a special port designated for launch. The agent specifies the launch port and a data collection port upon installation and registration with the cellphone operating system. Data on hardware configuration, software version and phone usage can be gathered. Data collection sessions are established by the data collection server sending a message addressed to the public P address of the cellphone and the data collection port specified by the agent process upon registration with the operating system. Many alternative embodiments are also disclosed. Also disclosed are a method and apparatus for downloading information about the characteristics and usage of cell phones and other mobile devices from the cell phones and mobile devices and for downloading other information about cell phone users and plans from servers operated by cell phone providers and the organization that supplies cell phones to its employees. Also disclosed are a user interface and various processes for analyzing data regarding cell phone characteristics, usage, providers, loaded applications, over utilization and under utilization, etc.

### FIELD OF USE AND BACKGROUND OF THE INVENTION

Many businesses give cell phones to their employees for business usage. The IT department wants to keep track of which software version is installed in each phone and what types of phones are in the hands of their employees. They want to know this for compatibility of ugrades to the phones and to know which phones, if any, need upgrades or to which new software can be downloaded. The company may also want to monitor usage of the phones so as to allocate budget usage amounts to its various departments. It may also want to monitor usage to make sure most usage is business related.

As far as the inventor is aware, the prior art has no convenient solution to this problem. Currently, the company will get multiple paper cell phone bills, each indicating the cell phone number of the phone being used and the phone numbers called and the minutes consumed. No indication of the phone's software version or make and model is included on these bills. No indication of which phone number is assigned to each department is included on these bills. The IT department would have to manually look up the software and hardware version for each phone and would have to determine manually from paper records which phones are assigned to which employees and which departments they are in. Then, the accounting department would have to group the bills into groups by department manually and add up the usage minutes manually. All this is time consuming and labor intensive and not attractive to IT departments or accounting departments of big and medium size companies.

Further, these bills come to the company on a monthly basis, and are not available on an as-needed, when-needed basis.

Accordingly, a need has arisen to gather information electronically from the phones themselves and collect and store that information in a database such that further inquiries can be made by mining the data in the database. Preferably, the information will be gathered on an as-needed, when-needed basis.

### SUMMARY OF THE INVENTION

The teachings of the invention define a genus of cellphone processes and a genus of collection server processes defined as follows. Before the process genus can be defined however, it is necessary to consider the following precondition which must be true before any species within the genus can execute.

A) an agent program (or some operating system functionality which can perform the functions of the agent program described herein—which will hereafter be referred to as the OS agent function) must be resident or remotely installed on a cellphone before data about said cellphone is to be gathered.

The genus of the cellphone process is defined by the following steps:

1) launching the agent process (or some operating system functionality which can perform the functions of the agent program described herein) in any way and collecting data about a cellphone;

2) establishing a data collection session with a data collection server in any way;

3) sending the data to the collection server in any way.

There is a preferred subgenus within this genus where all species have agents (or some operating system functionality which can perform the functions of the agent program described herein) which are remotely launched by the collection server which then initiates a data collection session. In this subgenus, there is one precondition to the process. That precondition is that the agent program, if an agent program is used as opposed to an operating system function, must register with the operating system of the phone upon installation and designate a launch port which if any message is received addressed to that launch port will cause the agent program to be launched. In embodiments where the functions of the agent are performed by some operating system agent function, the operating system must be configured such that whenever a message is received directed to a particular port associated with the OS agent function, the operating system will launch the OS agent function.

The cellphone process preferred subgenus is defined by the following functions that all species within the subgenus will perform:

1) when a message is received which is addressed to said launch port, said agent program or OS agent function is launched;

2) the agent or OS agent function monitors a data collection port for a message from a data collection server;

3) when a message is received at said data collection port, the agent or OS agent function sends back data about the phone.

Various species within this genus vary in the following ways. One species only launches the agent or OS agent function if the phone is not in use to make or receive a call. Another species allows the agent or OS agent function to be invoked, gather data and report back even while the phone is in use. Another species has the agent or OS agent function gathering all available data that can be gathered and sending it all back to the collection server when a message is received at the data collection port. Another embodiment gathers only data specified in the message received at the data collection port and sends only that data back to the collection server. Another embodiment gathers all the available data by the agent or OS agent function but sends back only data requested by the data collection server. Another species sends back a handshake message when a message is received at the data collection port. Another species specifies both the launch port and the data collection port upon registration. Another species specifies only the launch port upon registration and the data collection port is established by a handshake protocol between the agent or OS agent function and the collection server.

There is a separate invention involving business use of the information gathered by the phone in the collection server, possibly along with other information gathered from other servers such as from the provider's servers or servers of the phone manufacturer or the manufacturer of the phone operating system. For example, a company which provides cell phones to its employees may have business interests regarding use of the data gathered from the phones which can be broadly categorized into the areas of: phone analysis; spending analysis; call analysis; security management; maintenance support; and GPS location. For example, in the area of phone analysis, it is useful to a large company with many phones in the hands of its employees to be able to easily gather information about how many phones are in the hands of its employees, what make and model they are, what operating system and version they have, whether they have any virus protection software installed or not. This information can be used to negotiate with vendors of phones to negotiate package deals or to get subsidized prices on phone handsets from the vendors, determine if standardization on certain features is needed, or determine whether or not the company is spending too much on acquisition of phones, etc. In the area of spending analysis, the company may be interested in determining how much money it is spending on the plans provided with its phones and with which vendors for purposes of negotiating better packages with vendors. In the area of call analysis, the company may be interested in determining the average outgoing and incoming call length distribution and the time of day distribution of calls as well as determining who is being called and who is calling in. This type of information is useful to the company to determine if it has the right package of plans for its phones and could be sold to phone service provider marketing departments for purposes of developing new plans for big and small businesses.

### BRIEF DESCRIPTION OF THE DRAWINGS

FIG. 1 is block diagram of a typical cellular phone network showing how the data collection server is coupled through the internet to a server at the cellular provider.

FIG. 2 is a flowchart of the process to remotely launch the agent program, collect data, send the data to the collection server and shut down.

FIG. 3 is a flowchart of the process carried out in the phone when the agent is told what to collect by the collection server and collects only that information and sends it back to the collection server.

FIG. 4 is a flowchart of another embodiment of a process carried out in the cellphone to launch the agent and collect information but differing in that the agent can be launched and collect data and send that data to the collection server even while the phone is in use.

FIG. 5 is a flowchart of another species of a process carried out in a cellphone like FIG. 4 but the agent collects all available data and reports it all or just the data requested.

FIG. 6 is a flowchart of the genus of the cellphone process.

FIG. 7 is a flowchart of the preferred embodiment of a process to run on the server to do timed collections of data from cell phone agents.

FIG. 8 is a diagram of one type of display for a phone analysis application run on the collection server 32.

FIG. 9 is a diagram of one type of display for a phone analysis application executing on the collection server 32.

FIG. 10 is a diagram of one type of display for call analysis executing on the collection server.

FIG. 11 is a diagram of one type of display for a different type of call analysis based upon type of call.

FIG. 12 is an example of a display in bar graph form resulting from call analysis processing in the collection server to determine and display the average duration of outgoing calls.

FIG. 13 is an example of a display in bar graph form resulting from call analysis processing in the collection server to determine and display the average duration of incoming calls.

FIG. 14 is an example of a display in pie chart format resulting from spending analysis processing in the collection server to determine spending by carrier.

FIG. 15 is an example of a display in pie chart form of spending analysis by the collection server to determine spending for different plan minute levels.

FIG. 16 is an example of a display in pie chart format of spending analysis by the collection server to analyze which particular types of employees are using a particular plan type.

FIG. 17 is an example of such a spend analysis display showing average overutilization and average underutilization of various individual employees.

FIG. 18 shows a schematic diagram of the hardware architecture of the information gathering process.

FIG. 19 comprised of FIGS. 19A and 19B is a diagram of an exemplary user interface for the analysis application run on the collection server which allows the user to specify which particular type of analysis he desires.

FIG. 20 is a schematic diagram of a generic software architecture to collect the information from the phones, provider databases and enterprise database

FIG. 21 is a flowchart of a process to determine what type of analysis the user wants and just retrieve the data needed to make the required report.

FIG. 22 is a flowchart of another embodiment wherein the collection server gathers all the possible data and then just analyzes the data necessary to satisfy the request.

FIG. 23 is a flowchart of a third embodiment wherein all possible data is collected and all possible reports are calculated but only the report requested by the user is displayed.

FIG. 24 is a flowchart of a process wherein all the data from all the sources is gathered on a periodic basis with a different interval for different types of data.

### DETAILED DESCRIPTION OF THE PREFERRED AND ALTERNATIVE EMBODIMENTS

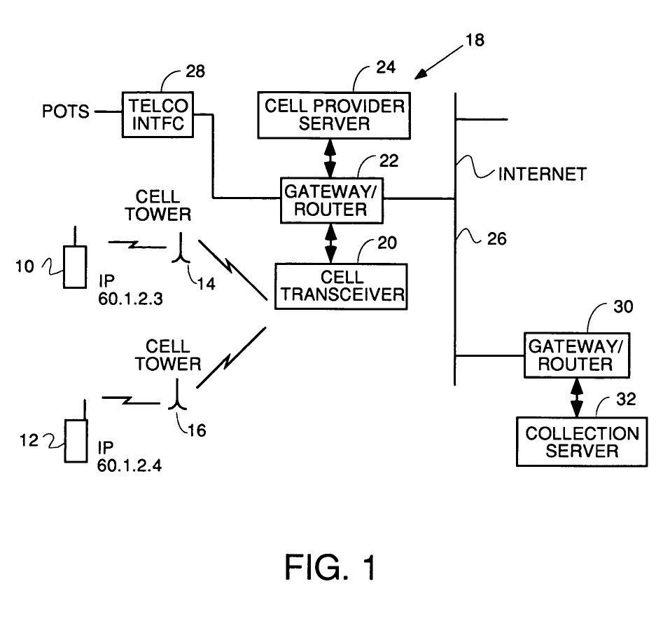

Referring to FIG. 1, there is shown a block diagram of a typical cellular system in which the teachings of the invention may be employed. Cell phone 10 and cell phone 12 are each web enabled cell phones. They are each coupled by radio frequency transmissions through a series of cellular towers such as 14 and 16 to the cellular system head end. The head end 18 of the cellular system is well known and typically includes an RF transceiver 20 coupled to a gateway/router 22. The gateway/router 22 is coupled to a server 24, the Internet 26, and the conventional telephone company land lines through a telephone company interface 28. Each cellular phone has an IP address which may be globally unique or which may be locally unique within the cellular system and converted to a globally unique IP address through a network address translation (NAT) process carried out in the gateway/router 22.

A gateway/router 30 couples a collection server 32 to the internet 26. The data collection server 32 could also be directly coupled to a local area network to which the provider's server 24 is coupled, but typically it is not and data is transferred over the internet. The address of the cellphone must be either a globally unique IP address that routers on the internet have in their routing tables, or a network address translation router that couples the providers network to the internet via a globally unique IP address of the NAT router and a NAT address translation table must be used.

In the preferred embodiment, all the cellphone IP addresses are public, but the collection server IP address is private. Thus, collection of data sessions can only be initiated from the collection server 32 in the preferred embodiment and not from the cellphones. In other embodiments, the data collection server has a public IP address and the cellphones can initiate data transfers thereto.

The function of the collection server is to execute a process to collect information from the cell phones which is stored in a database. This database can be mined by the IT and accounting departments of a company that provided the cell phones to its employees to extract information needed by those departments. The collection server carries out this process by carrying out a protocol to be described below to activate a data collection agent in each cellphone it wants to extract information from and receive packets back from each cellphone that contains data about the cellphone and its usage. The server can also associate each cellphone with an individual employee and/or department of the corporation. Information can be gathered from individual cellphones or the entire lot or any subset of the cellphones, and the information can be gathered when needed.

Each cellphone has to be digitally enabled on the cellphone provider's digital data exchange network, and it has to have either a globally unique IP address or a unique local address within the provider's digital network which can be translated by NAT to a globally unique IP address. NAT replaces the source address in each outgoing datagram from a cellphone agent with the globally unique IP address assigned to the NAT router 22. Likewise, incoming packets from the internet addressed to the NAT router 22 have their destination addresses changed to the locally unique address of the cellphone to which the data packet is addressed. These incoming packets are routed to the appropriate one of the cellphones on the cellphone local area digital data network using an address translation table in the NAT router 22. The NAT routing table contains two items of information for each cellphone: the IP address of the host on the internet; and the internal IP address of the cellphone on the cellular provider's network. This table must be in place before the first incoming packet intended for a cellphone arrives at the NAT router. There are several possible embodiments for initializing (filling with address translation data) this NAT routing table.
1) Manual Initialization: A manager configures the translation table manually before any communication occurs. Port numbers in the TCP/IP packet headers can be used to distinguish between different cellphones as the destination.
2) Outgoing datagrams: The NAT routing table is built as a side-effect of sending datagrams from the cellphones to the collection server. When a datagram is received at NAT router 22 from one of the cellphones, a software process automatically makes a NAT routing table entry recording the local address of the cellphone and the globally unique IP address of the collection server. This alternative can only be used in embodiments where the agents initiate communication with the collection server before the collection server sends any packets to the cellphones. Such a class of embodiments includes an embodiment where a cellphone agent initiates a session with the collection server upon power up of the phone or at some other time and registers itself with the collection server.
3) Incoming Name Lookup: The NAT routing table is built as a side-effect of handling 2 5 domain name lookups. When a host on the internet such as the collection server looks up the domain name of one of the cellphones to find its IP address, the domain name software creates an entry in the NAT translation table, and then answers the request by sending the globally unique IP address of the NAT router 22. Thus, to the servers on the internet, it appears that all cellphone host names in the cellular system map to the globally unique IP address of the NAT router 22.

The address of each cellphone must be accessible to the router 30 so that the data collection server 32 can communicate with each phone. In the preferred embodiment, each cellphone has a globally unique IP address and if the cellular provider uses NAT, each cellphone contract will include a surcharge to cause that cellphone to be assigned a globally unique IP address. In alternative embodiments where NAT is used by the cellular system provider, the collection server 32 communicates with each cellphone in the conventional manner in which all prior art NAT systems work.

The cellphone must have an agent program (or some operating system functionality which can perform the functions of the agent program described herein) which is resident in the preferred embodiment, or which can be downloaded, installed and launched remotely by the collection server 32 in other embodiments. Downloading, installation and remote launching of programs digitally is known in the prior art of head end apparatus downloading programs to digital set top boxes in DOCSIS digital data delivery cable systems. In the preferred embodiment, the IT department that gives a cellphone to an employee will manually install the agent program in the phone before delivering it. In other embodiments, the IT department can upload the agent program to a server of the cellphone provider. The server of the cellphone provider then sends TCP/IP packets to the particular cellphone which include an agent program. In the preferred embodiment, the cellphone provider server then sends a message to the phone upon which the agent is to be installed saying there is a new application the server would like to install on the phone. If the phone owner permits the installation by giving some command, the phone launches an installer program which downloads the agent program from the cellphone provider server and installs it. The installer program comes with the phone and is the same installer as is used to download and install games, ringers, etc. In other embodiments, the cellphone provider server just receives the message that the application may be installed and sends TCP/IP packets containing the agent program to the phone. These TCP/IP packets will be addressed to a port which signals the J2ME software (or whatever other operating system the phone has) in the phone to invoke an API function to invoke an installer program to receive the TCP/IP packets containing the agent program and install it in the phone in a resident state ready to be launched. In the preferred embodiment, the user of the phone is involved in the installation to answer yes or no to a query as to whether he wants the agent program to be installed. This embodiment is preferred because it prevents applications from being installed surreptitiously on the phone. In other embodiments, the agent program will be installed in the background and no user involvement or knowledge that a new application has been loaded is necessary.

In the preferred embodiment, the agent program or OS agent function is launched by the collection server 32 only when the server 32 wants to collect information. In the preferred embodiment, the agent or OS agent function will only run when the cellphone is not in use in making or receiving a call. Many cellphones can only run one program at a time. In alternative embodiments, where a cellphone can run multiple programs simultaneously, the agent can be launched at any time by the collection server. In still other alternative embodiments, the agent can be running in the background at all times and continuously collect information and send it to the collection server at the initiation of the agent by establishing a secure or non secure session over the internet with the collection server. In the preferred embodiment however, the initiation of a data collection session with an agent can only be initiated by the collection server.

Typically, each cellphone will have J2ME (Java 2 Micro Edition) software loaded in addition to whatever operating system or simple BIOS (Basic Input Output System) the manufacturer of the cellphone installs. Effectively, J2ME is the operating system. Hereafter, references to the operating system refer to the J2ME layer. J2ME is a Java Virtual Machine which presents an application programmatic interface (API) that allows certain functions to be invoked. Other operating systems will work to practice the invention also. For example, the BREW phone operating system from Qualcomm or Microsoft PocketPC operating system can also be used. Therefore, J2ME as a phone operating system or layer of functionality above the phone operating system is not a required element to practice the invention. However, there must be some software which presents an API which allows the phone functionality needed to practice the invention to be invoked. The API functions needed are as follows (some are optional).
1) Install and execute an installation program to load another program: in the preferred embodiment, software cannot be loaded without a human interacting with the phone. Typically, the agent program will be installed manually by the IT department. However, the agent program can also be downloaded over the RF digital data link and installed on the phone remotely. Typically, this requires permission from the operator of the phone, but in some embodiments, the agent program can be downloaded over the RF data link and installed on the phone remotely without the user of the phone knowing about it or having to give permission. Remote installation would be done by sending IP packets that contain the agent to the cellular provider server 24 along with a list of phones upon which the agent is to be installed. The provider's server 24 then sends messages to all the phones on the list and which need the agent program. Each user of such a phone receives the message and has to consent to loading of the agent. If the user consents, server 24 encapsulates the agent program into IP packets addressed to each phone which consents. These IP packets get routed to the phone by the router 22 in the network of the cellular service provider. When the IP packets get to the phone, they are passed up through the TCP/IP layers to the J2ME layer to invoke this install/execute API function to execute an install program and install the agent program encapsulated in the IP packet's payloads into the phone.
2) Network connectivity: this function establishes connectivity to a particular port by a program. For example, this function can be invoked when a program wants to listen for packets addressed to it from other programs. A program could invoke this function and pass the port number of the port it wants to listen to as part of the function call. The API function would then execute and establish the designated port as associated with the calling program so that packets addressed to that port would be passed to the calling program.
3) Remote invocation of a program: this is an underlying operating system function which on a specific port for a specific message which will launch the agent program. An agent program on a particular phone can be launched by sending a datagram addressed to the phone's IP address (or local address in the case of NAT) and to a particular port which is dedicated to the agent program. Whenever a datagram or text message is received which is addressed to the phone and to this particular port, the operating system launches the agent program so that it can gather data from the phone and send it back to the collection server 32. The collection server 32 knows which IP address each cellphone has and knows which port the phone's operating system is listening to for a start message. When the agent program was installed, registers itself with the operating system of the phone and designates the port. The operating system know from this registration that whenever it receives a datagram or text messaged addressed to that port number of the phone that it must launch the agent program by invoking this remote invocation of program function call.
4) Access phone data: this function call allows the agent to gather information from the operating system or J2ME layer about the cellphone and its use including information on:
   phone make and hardware version information
   operating system software version information
   provider identity
   the existence or non existence of any virus protection software in the phone
   usage information
      call timers
      the included minutes or other plan the phone is on if that information is stored in the phone or the electronic serial number of the phone;
      the configuration file privileges such as web access, picture sending and receiving capability or other data reception sending and receiving capability of the phone
      list of incoming and outgoing calls or missed calls
      GPS location and possibly tracking of locations over time
      list of names and phone numbers in the phone's address book
   and whatever other information which can be gathered about the phone or its usage which would be a useful piece of information to manage a company's cellular phone program.

The agent program itself does not have an API in the preferred embodiment, but in other embodiments, the agent program or OS agent function could have its own API such as providing function calls that can be invoked to gather each specific different type of information.

The data collection process and apparatus described herein are self contained and does not rely on the cellphone provider's billing system or any other operation of the server of the cellphone provider. The only qualification to this statement is that some embodiments involve the cellphone provider's server to install agent programs over the radio frequency data transport process provided by the cellphone provider's network.

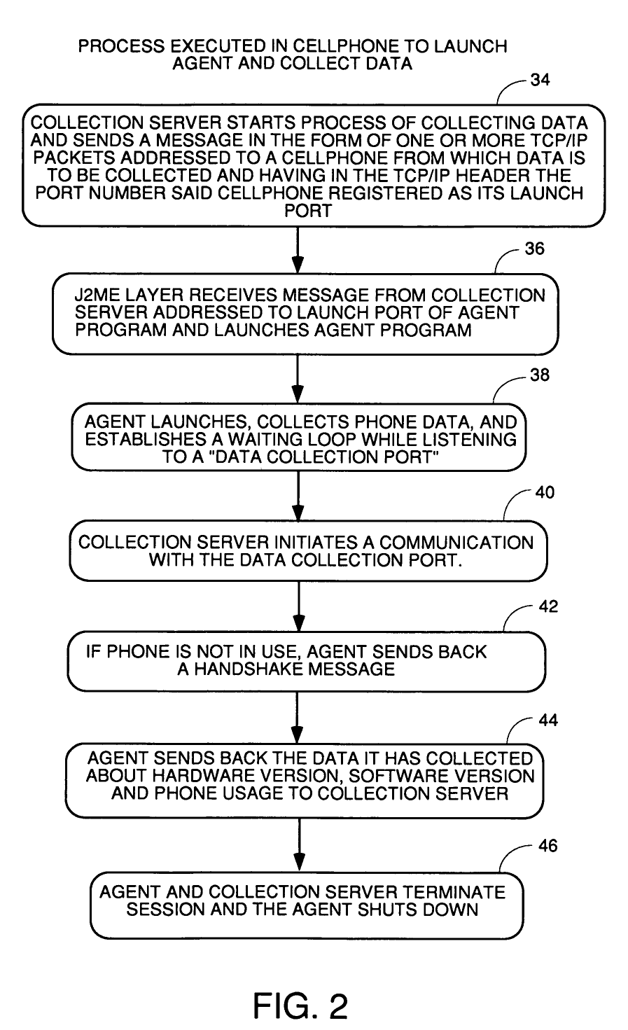

Referring to FIG. 2, there is shown a flowchart of the process to remotely launch the agent program or OS agent function, collect data, send the data to the collection server and shut down. Before the process of FIG. 2 can be executed, an agent program has to be installed in the phone and must have registered with the operating system to identify a port. That port will be the port at which, if a message is received addressed to that port, the operating system will know to launch the agent.

At the beginning of the process of FIG. 2, the agent program has been previously installed but is not executing in the preferred embodiment. The teachings of the invention contemplate that the agent's functionality will eventually be incorporated as a function of the operating system which can be invoked through a procedure call to the operating system or through an API function call. Hereafter, any reference to the agent should be understood as also referring to operating system functionality which performs the functions of the agent program if no specific reference to OS agent function is made.

Step 34 represents the process of remotely launching the agent OS agent function. In step 34, the collection server starts the process of collecting data by sending a message in the form of one or more TCP/IP packets addressed to a cellphone from which data is to be collected. These one or more TCP/IP packets will have in their headers the port number which the agent program or OS agent function of the cellphone being addressed registered as its launch port. In step 36, the J2ME software layer receives the message from the collection server addressed to the launch port of the agent program or OS agent function and launches the agent program or OS agent function as a result by invoking the appropriate API function call.

In step 38, the agent or OS agent function launches and collects data about the phone hardware version, software version and usage. The agent or OS agent function also establishes a waiting loop while listening to a data collection port. This port number is known to both the collection server and the agent or OS agent function. In the preferred embodiment, the data collection port is specified by the agent program when it registers with the operating system upon being installed along with the launch port. The launch port is the port which, if any message is received which is addressed to the launch port, the agent program or OS agent function will be launched. In alternative embodiments, the data collection port can be established by a handshake protocol between the agent program or OS agent function and the collection server. In some embodiments, the data collection port number is known to the collection server because all agents register the same port number with their operating systems. In other embodiments, the agent program or OS agent function will send a message to the collection server after it has registered telling the collection server which port has been assigned as the data collection port. In this embodiment, the collection server must have a public IP address or be in the same network with the cellphone provider's servers.

There are three different species for collection of data by the agent program or OS agent function. In the preferred species, illustrated in FIG. 2, the agent program or OS agent function launches and then waits while listening to the data collection port for messages from the data collection server. These messages are addressed to the data collection port and requests the agent program or OS agent function to send back all the data it has collected about the phone. In the preferred embodiment, the agent or OS agent function collects whatever data it can collect when it launches and then waits for the collection server to ask for all the data it has. In another embodiment, these messages sent by the data collection server to the phone's data collection port specify exactly which data the collection server wishes to collect, and the agen or OS agent function t collects only that data. In a third embodiment, these messages specify what data the collection server want to collect, and the agent or OS agent function collects all the data it can collect but only sends back the data which the collection server asks for.

In step 40, the collection server 32 uses the public IP address of the cellphone from which it desires to collect data and sends a message to that IP address with the data collection port number in the TCP/IP packet headers. It is possible that multiple data collection servers who have the IP address of the cellphone will all try to collect information from the phone. In the preferred embodiment, only the collection servers can initiate communications with the cellphone to collect data, and not the other way around. The server will try to establish communications with the phone for some predetermined amount of time, and if communications are not successfully established, the server process will time out and the data collection effort will be put in failed status and may be rescheduled for later.

In step 42, communication will be established by the agent or OS agent function if the phone is not in use by the agent receiving the message sent by the collection server to the data collection port and sending back a handshake message. In alternative embodiments, the handshake can be dispensed with. In other embodiments where the phone is multithreading and other concerns such as privacy do not preclude it, the agent or OS agent function can be launched even when the phone is in use. In some embodiments, the agent or OS agent function can be launched while the phone is in use and can collect phone data while the phone is in use. In still other embodiments, the agent or OS agent function launches itself automatically when the phone is in use, and part of the data collected is the phone conversation held on the phone. The phone conversations is stored in digital, compressed form in a file stored on the phone until the collection server initiates a data collection session.

In step 44, the agent process or OS agent function sends back to the collection server the data it has gathered about the phone hardware version, the software version, phone usage and whatever other information the agent or OS agent function has gathered. In other embodiments, the agent or OS agent function does not just automatically gather all the information it can gather but waits to receive a message in step 40 from the collection server specifying which information the collection server wants and then just gathers that information and sends it back in step 44.

The collected data can be in any format such as fields separated by delimiters or a concatenation of fields each of a defined length with the entire file marked by delimiters at the beginning and end. The transport mechanism is the native mechanism used by J2ME (or whatever other operating system is present in the phone) and the cellular system provider, such as IP packets which are parsed and encoded into symbols with forward error correction techniques and then code division multiplexed.

In step 46, the agent or OS agent function and collection server terminate the session and the agent shuts down so as to conserve phone resources.

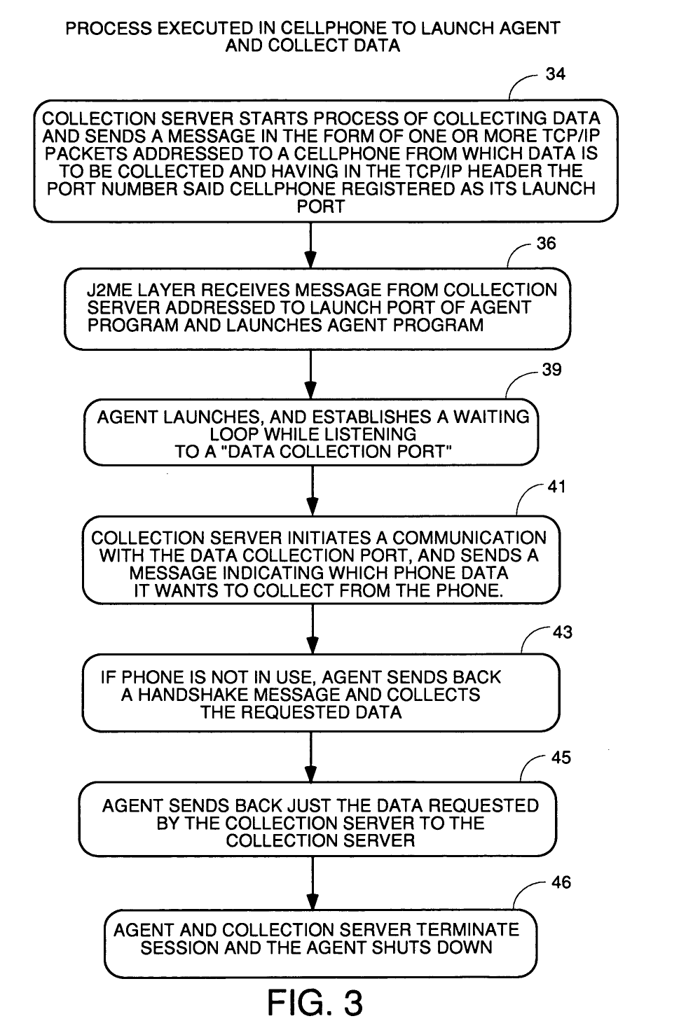

FIG. 3 is a flowchart of the process carried out in the phone when the agent or OS agent function is told what to collect by the collection server and collects only that information and sends it back to the collection server. All steps that have identical reference numbers to steps in FIG. 2 are the same. Step 39 differs from step 38 in FIG. 2 in that the agent or OS agent function launches and does not immediately gather all the available information about the phone as it does in the embodiment of FIG. 2. Instead, the agent or OS agent function just launches and goes into a waiting loop waiting for requests for specific data from the collection server. In step 41, the collection server attempts to establish communication with the cellphone by sending a message to the data collection port of the cellphone. That message specifies which information the collection server wants to collect. In step 43, the agent or OS agent function sends back a handshake message if the phone is not in use, and collects the requested data from the cellphone's operating system. In step 45, the agent or OS agent function sends back just the data requested by the collection server which was collected in step 43 to the collection server. Thereafter, the session is terminated and the agent or OS agent function shuts down.

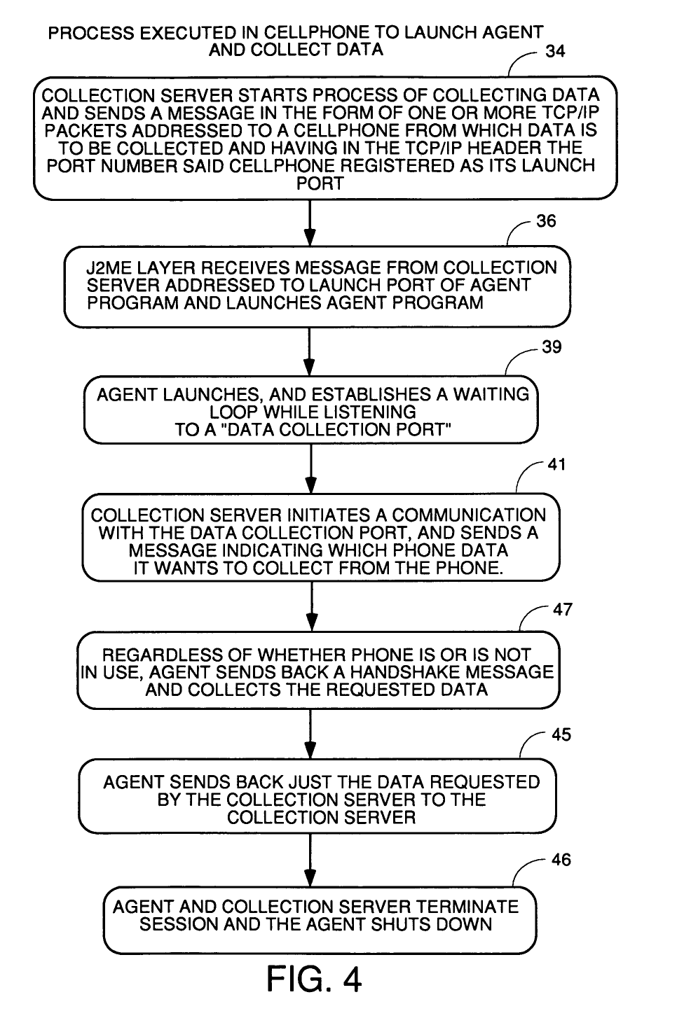

FIG. 4 is a flowchart of another embodiment of a process carried out in the cellphone to launch the agent or OS agent function and collect information but differing in that the agent or OS agent function can be launched and collect data and send that data to the collection server even while the phone is in use. Steps which have the same reference numbers as steps in FIG. 3 have the same function and operation. The difference over the embodiment of FIG. 3 is in step 47. There, the agent or OS agent function sends back a handshake message to the collection server in response to the collection server initiating a data gathering session, and this happens regardless of whether the phone is in use or not. In the preferred embodiment, the J2ME software is multithreading and has the capability to do this so this embodiment can be practiced in a J2ME phone or any other phone with multithreading ability of its operating system.

The embodiment of FIG. 4 carries out a process where the collection servers specifies just the data it wants and the agent or OS agent function collects only that data.

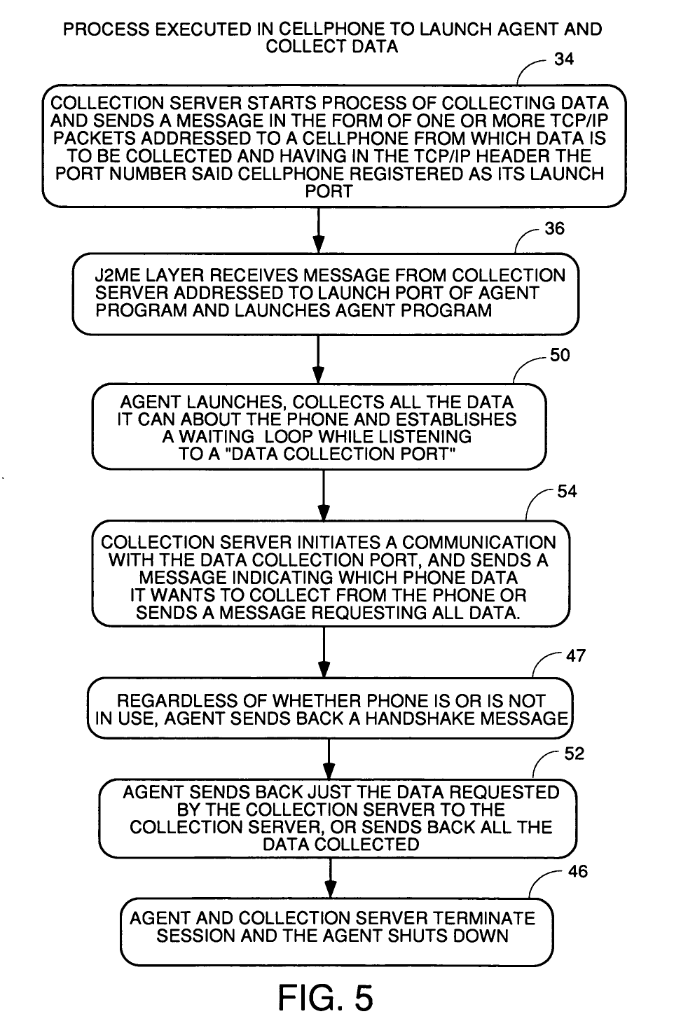

In the alternative embodiment represented by FIG. 5, the agent or OS agent function collects all the possible data in step 50. The collection server in step 54 establishes a data collection session with the phone and either sends a message requesting certain pieces of information be sent or sends a message requesting all the collected data be sent. The agent or OS agent function then sends all the collected data to the collection servers in step 52 or just the data specified by the collection server in the case where the collection server specified exactly which data about the phone it wanted. All other steps with identical reference numbers to steps in FIG. 4 have the same function and operation.

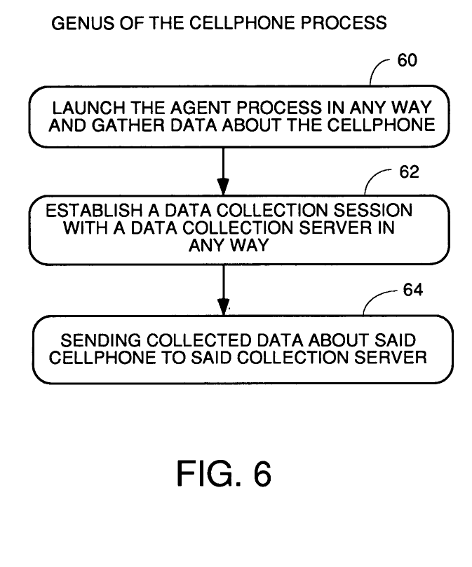

Referring to FIG. 6, there is shown a flowchart of the genus of the cellphone process. In step 60, the agent or OS agent function is launched in any way. In some species, it will be launched in the manner described in FIGS. 2-5 using a launch port. In other embodiments, the agent or OS agent function will be in execution at all times the phone is powered on. In still other embodiments, the agent or OS agent function launches itself whenever the phone is used to make a call or receive a call or do any other function. Step 62 represents the process of establishing a data collection session between the cellphone and the data collection server in any way. In some species it can be only initiated by the data collection server. In other embodiments, it can be initiated by the cellphone itself, such as whenever it has data to send, and where the data collection server has a public IP address. In step 64, collected data about the cellphone is sent to the data collection server for storage in a database. This can be done in anyway such by use of datagrams or by a File Transfer Protocol.

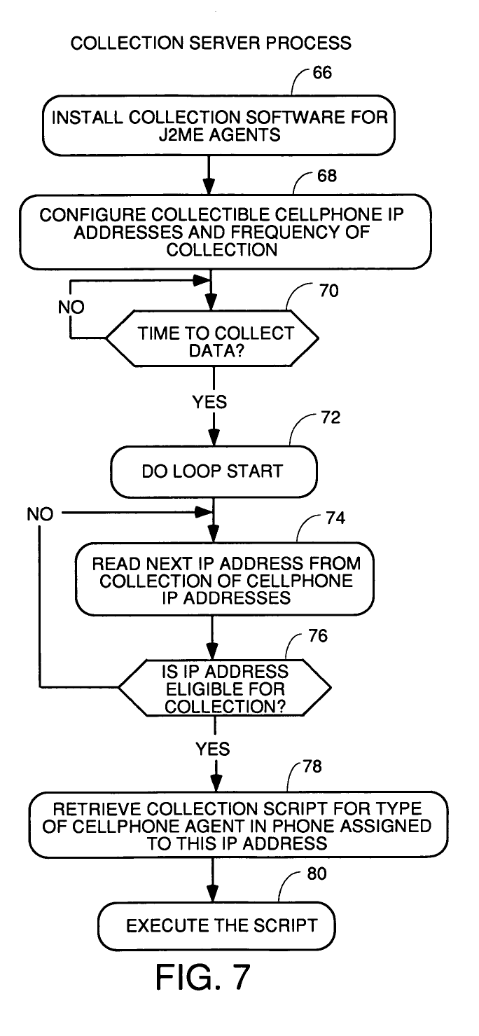

Referring to FIG. 7, there is shown a flowchart of the preferred embodiment of a process to run on the server. Step 66 is really a preliminary step of installing the collection software and the collection scripts for J2ME agents or OS agent functions. The collection software does the steps that follow the installation and configuration steps 66 and 68. Step 68 is another preliminary step which involves configuring a configuration file or database stored in nonvolatile memory to add the IP addresses of the cellphones from which data is to be collected and defining a frequency of collection and any restrictions such as do not collect during morning hours in this user's time zone or do not collect during commute times when the phone is likely to be busy.

Step 70 is the first step of the collection process. This step checks the time and determines if it is time to begin a collection cycle. If not, the system idles until it is or does other tasks. If it is time to collect data, processing calls a do loop routine which starts at 72. The first step of this routine is to read the next IP address from the list of IP addresses assigned to the cellphones being monitored, as symbolized by step 74. Test 76 reads the restrictions associated with this IP address and determines if the IP address is eligible for collection. If not, step 74 is performed again to read the next IP address from the group of addresses of cellphones. If the IP address is ready for collection, step 78 is performed to retrieve a collection script for the type of cellphone agent or OS agent function which has been installed in the cellphone assigned to this IP address. There are many different type of collection scripts for different computers and operating systems in the company and different types of cellphones.

In step 80, the script is executed. This involves launching the agent or OS agent function by creating and sending a datagram message addressed to the cellphone's public IP address and to the launch port of the cellphone. Next, the collection script trys to establish a collection session with the cellphone by sending a datagram to the collection port for some specified timeout period. If a collection session is established, and a handshake is received, the collection script receives the collected data, parses it and stored it in a database or other repository on the collection server.

### BUSINESS APPLICATIONS USING THE DATA COLLECTED FROM CELL PHONES

There are several different categories of application programs that can be run on the data collection server: 1) spend analysis which analyzes the spending on cell phone service by the employer who is supplying the cell phones to employees; 2) call analysis; 3) phone profile; and 4) location data.

Spending analysis involves analysis as to whether the employer is spending its budget for employee cell phone service in the most effective and efficient manner. That analysis can be subdivided into areas of analysis such as: 1) do we have the best mix of carriers; 2) are the plans we have well suited to the usage of the employees who are using the plans; 3) are the people using their company supplied cell phones and plans for company business or personal business and what is the ratio of usage; 4) which types of phones are the employees carrying and what capability does the phone each employee carries have such as will it receive a text message which the employer may want to send to all employees.

Call analysis may be relevant to the cell phone service provider, the employer and the phone companies who cooperate with cell phone service providers as well as the manufacturer of the phones being used. Call analysis involves analysis of what is the average outgoing call duration on an aggregate basis and on an individual basis, which numbers do the employees call, what percentage of calls are long distance, what is the average incoming call duration on an aggregate basis and on an individual basis, etc. Call duration averages are useful to phone manufacturers so they can design phones with battery capacity that meet most people's needs. It is also of interest to the employer who may want to know to which employees extra batteries should be given. The percentage of long distance calls is of interest to the cell phone provider and employer to adjust plans or generate new plans, set rates and analyze whether the best plan distribution is in effect.

Phone profile data is about capability of the phones. Data of interest includes what operating system software version and revision number exists for each phone, which manufacturer made the operating system, what ring tones are loaded on the phone, how much memory is in the phone, etc.

Location data is of interest to determine where employees are for purposes of coordinating jobs or dispatching of employees, helping solve crimes such as kidnappings in some foreign countries such as Columbia and other South American or Latin American or middle eastern countries where executives are kidnapped on a regular basis, locating the phones themselves to recover them, security such as locating lost phones before the confidential phone numbers stored in the phones are lost to unscrupulous persons, etc.

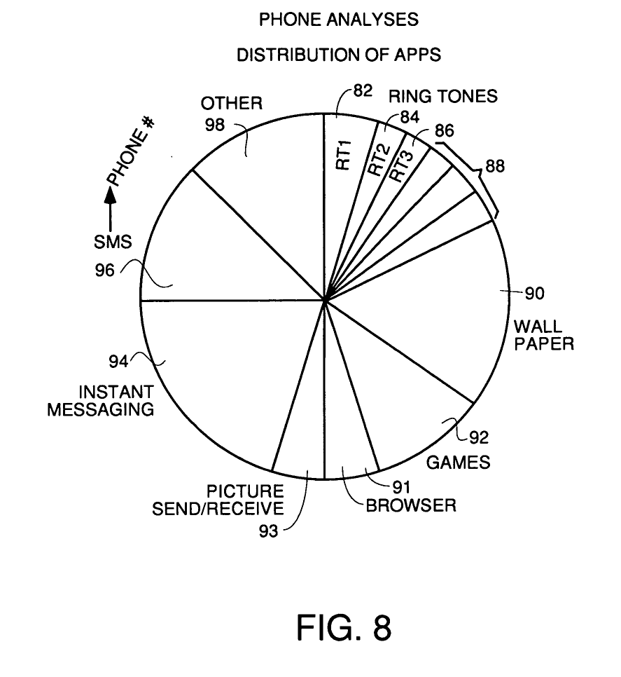

FIG. 8 is a diagram of one type of display for a phone analysis application run on the collection server 32. The idea of the display of FIG. 7 is to display the distribution of various phone applications among the cell phone population of phones distributed by the employer. In this example, a pie chart format was chosen to show the relative percentage of phones that have: ring tone 1 (slice 82), ring tone 2 (slice 84), ring tone 3 (slice 86), various other ring tones (slices shown generally at 88), wall paper applications (slice 90), games (slice 92), a web browser (slice 91), picture send and receive capability (slice 93), instant messaging (slice 94), short message service (slice 96), and other applications (slice 98).

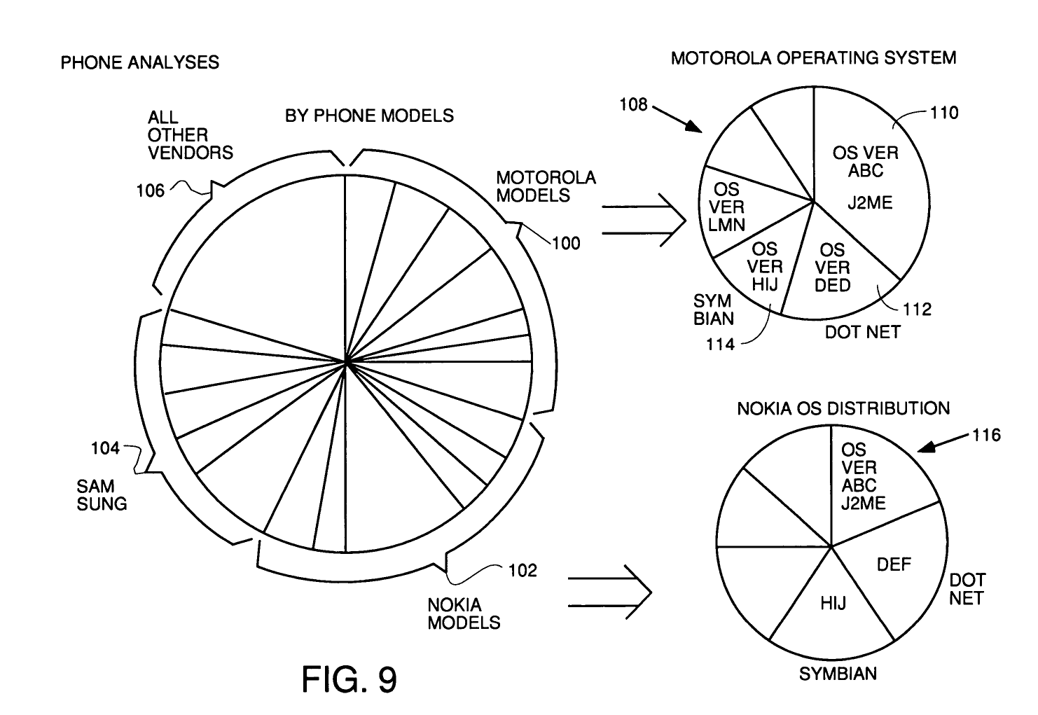

FIG. 9 is a diagram of one type of display for a phone analysis application executing on the collection server 32. The function of this particular phone analysis application is to determine the relative percentages versus the entire phone population of cell phones distributed by an employer of phones supplied by each a plurality of different vendors including Motorola (slices indicated generally at 100), Nokia (slices indicated generally at 102), Samsung (slices indicated at 104) and all other vendors (slices indicated at 106). Although a pie chart format was chosen for this display, other formats such as bar graphs, etc. could also be used. Another display is shown generally at 108 to show the relative percentages of the total cell phone population of phone manufactured by Motorola how many are running OS version ABC with J2ME (slice 110), how many are running OS version DED with dotnet (slice 112), or OS version HIJ with Symbian (slice 114), etc. A similar display shown generally at 116 shows the relative distribution of operating system versions among the Nokia cell phone population of phones supplied by the employer. The information shown in FIG. 9 is relevant to phone manufacturers because it allows them analyze how many phones a company owns which have obsolete OS versions which allows the marketing department to make a targeted proposal to the employer to replace the older phones with favorable terms. For employers, the information of FIG. 9 is relevant because it allows them to develop a coherent IT upgrade policy and be better able to anticipate their spending on upgrading cell phones or cell phone operating sytems.

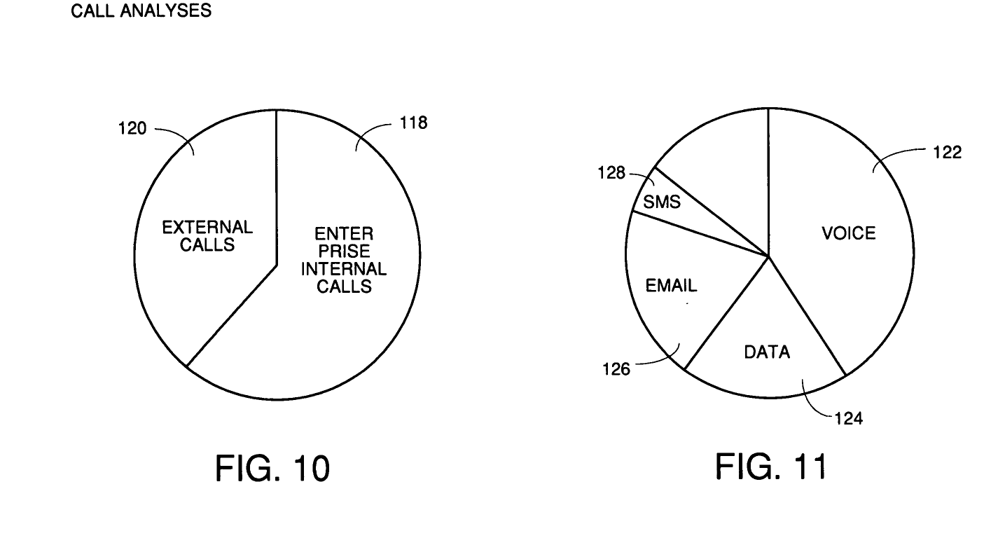

FIG. 10 is a display of a typical output of a call analysis application running on the collection server showing the relative percentages of enterprise internal calls (slice 118) versus external calls outside the enterprise (slice 120).

FIG. 11 is a display of a typical output of a call analysis application running on the collection server showing the relative percentages of voice calls, data calls, emails sent from the cell phone and short message service messages sent in slices 122, 124, 126 and 128 respectively.

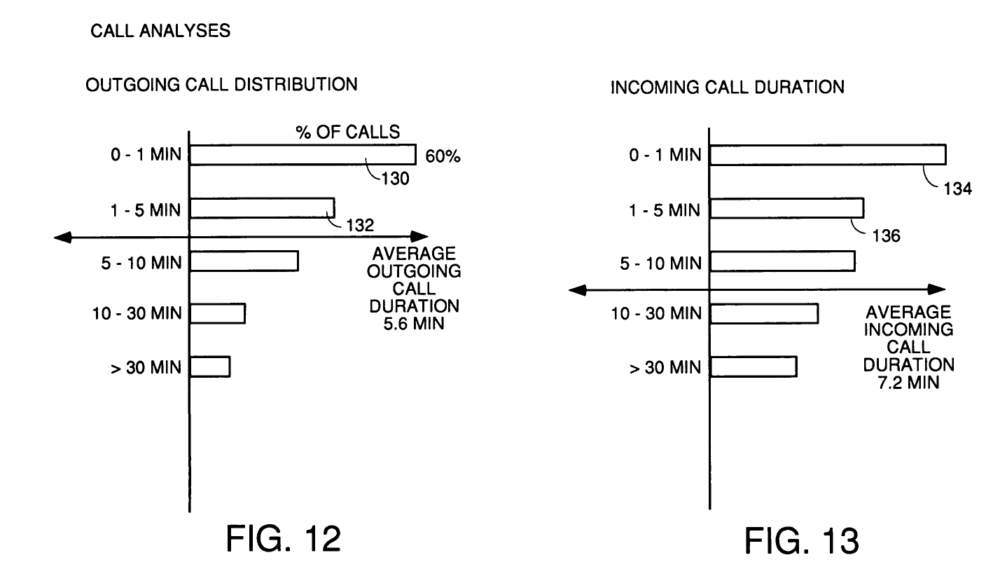

FIG. 12 is an example of a display in bar graph form resulting from call analysis processing in the collection server to determine and display the average duration of outgoing calls. A display like that shown in FIG. 12 can be generated by the collection server for both the distribution of outgoing call durations by a single user as well as all users of cell phones distributed by a particular employer. Bar 130 indicates the percentage of all outgoing calls of 0 to 1 minute duration, while bar 132 indicates the percentage of all outgoing calls of 1-5 minutes. The other bars show the percentage of all outgoing calls of 5-10 minutes, 10-30 minutes and greater than 30 minutes. This display could be in pie chart or other suitable formats also.

FIG. 13 is an example of a display in bar graph form resulting from call analysis processing in the collection server to determine and display the average duration of incoming calls. A display like that shown in FIG. 13 can be generated by the collection server for both the distribution of outgoing call durations by a single user as well as all users of cell phones distributed by a particular employer. Bar 134 indicates the percentage of all incoming calls of 0 to 1 minute duration, while bar 136 indicates the percentage of all incoming calls of 1-5 minutes. The other bars show the percentage of all incoming calls of 5-10 minutes, 10-30 minutes and greater than 30 minutes. This display could be in pie chart or other suitable formats also.

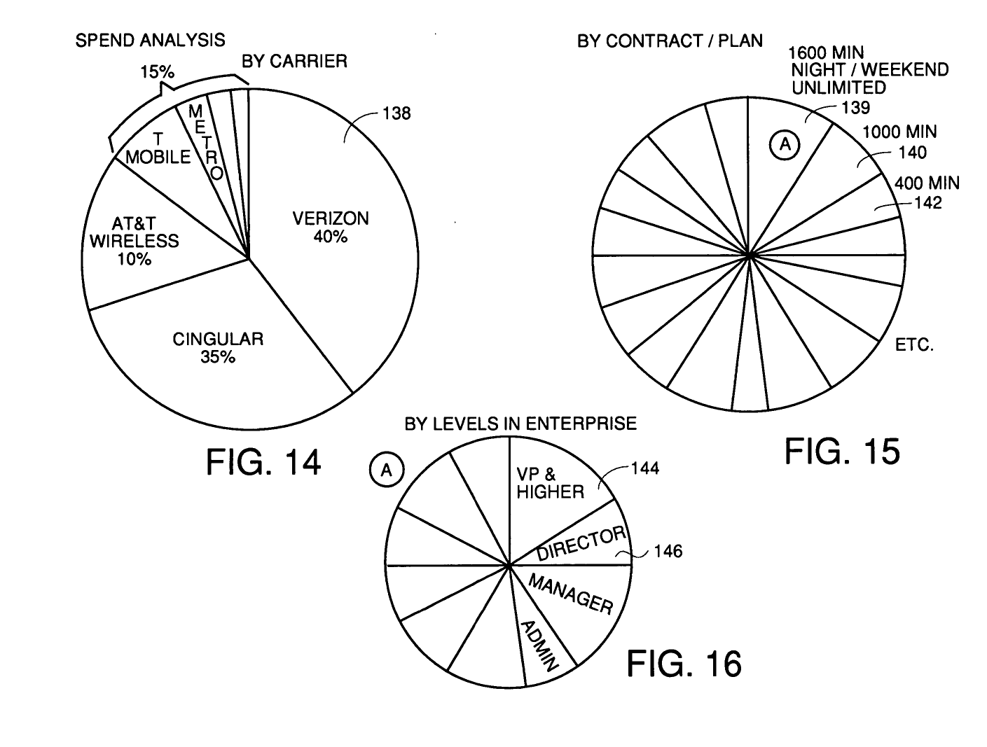

FIG. 14 is an example of a display in pie chart format resulting from spending analysis processing in the collection server to determine spending by cell phone service provider. Slice 138 shows that 40% of all the cell phone service plans which service the phones of employees of the employer are provided by Verizon. The other slices show the percentage of the total number of plans which are provided by other vendors. This information is valuable to both the employer and cell phone provider to determine is a company should standardize on one provider or not. This information is valuable from the enterprise prospective because it enables the enterprise to approach vendors and negotiate better deals by promising to consolidate all their service with one provider.

FIG. 15 is an example of a display in pie chart form of spending analysis by the collection server to determine spending for different plan minute levels. Slice 140 shows the percentage of plans that include 1000 minutes, and slice 142 shows the percentage of plans that include 400 minutes.

FIG. 16 is an example of a display in pie chart format of spending analysis by the collection server to analyze which particular types of employees are using a particular plan type. In the example given, the 1600 minute primetime slice 139 with unlimited night and weekend minutes is analyzed by the display of FIG. 15 to determine which types of employees within the enterprise are using this type of plan. In this example, slice 144 indicates the percentage of the total employees at the vice president and higher level of the company are using the 1600 minute plans represented by slice 139. Slice 146 indicates how many employees at the director level are using the 1600 minute plan. This information is valuable to the enterprise in that it can use the information to set a policy that only VPs and higher can have high included minute plans but certain employees with a demonstrated need who are not VPs may also have the high included minute plans.

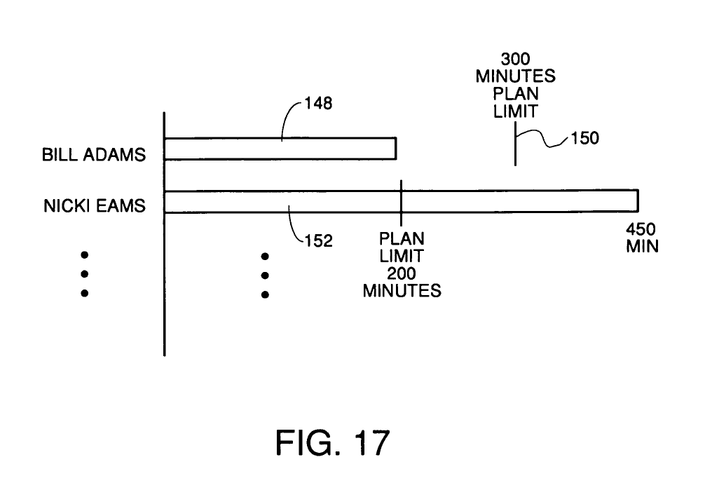

In some embodiments, spend analysis includes a display that shows for each employee of an enterprise to whom a cell phone has been issued his average under-utilization or over-utilization of his included plan minutes. FIG. 17 is an example of such a spend analysis display showing average overutilization and average underutilization of various individual employees. Bar 148 shows average usage for Bill Adams at approximately 200 minutes and that he has a plan limit of 300 minutes represented by line 150. Bar 152 shows an average overutilization by Nicki Eams with an average monthly usage of 450 minutes and a plan limit of 200 minutes. This information is useful to the enterprise to adjust the plans its employees have or to set policies on cell phone usage by employees. It is also useful to cell phone service providers to be able to understand patterns of usage by employees within an enterprise so that new plans or incentives can be developed.

Gathering Information From Phones, Carrier Databases, Enterprise Database(s)

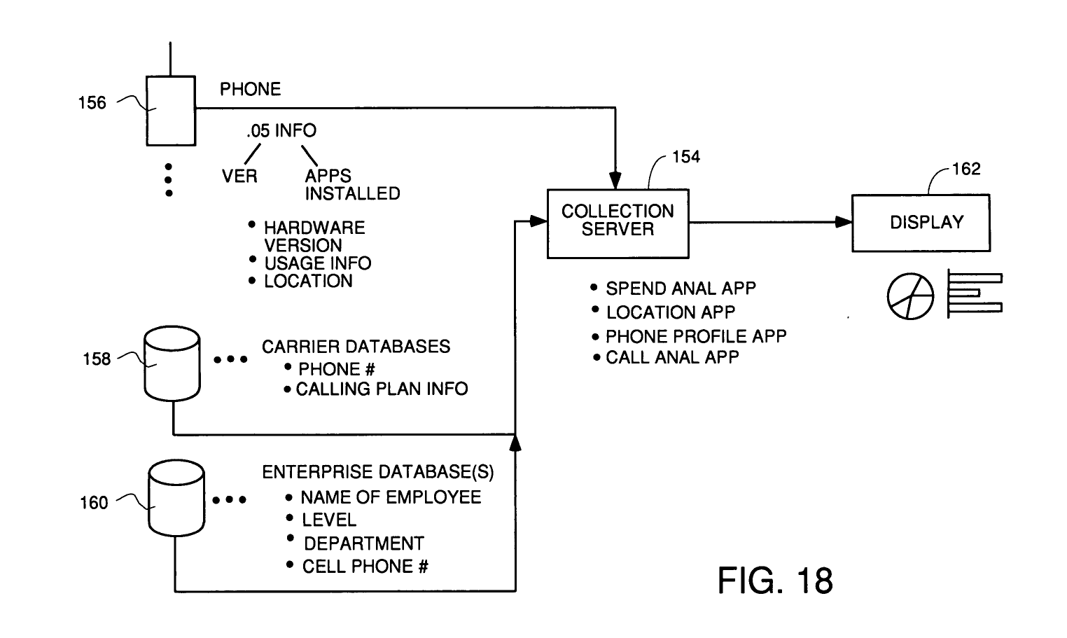

Information needed to support the above described types of phone profile, spend analysis, call analysis and location analysis is gathered by the collection server. FIG. 18 shows a schematic diagram of the information gathering process. The collection server 154 is programmed with an operating system, and scripting programs that control gathering of information from the cell phones 156, databases 158 of one or more cell phone service providers, and one or more enterprise databases 160. The collection server is also programmed one or more applications that use the data collected by the scripting programs to do spend analysis, phone profile, call analysis and locating services. Use of scripts to gather information from diverse databases is taught in U.S. patent application Ser. No. 10/125,998, filed Apr. 18, 2002 entitled APPARATUS AND METHOD TO AUTOMATICALLY COLLECT DATA REGARDING ASSETS OF A BUSINESS ENTITY, which is hereby incorporated by reference. The methods taught earlier herein are used to gather information from the cell phones. In the cell phones, data collected by the phone's operating system such as OS version, application programs installed, hardware version and manufacturer, call duration information and the phone's physical location are accessed by the cell phone's agent program. In some embodiments, the information gathered by the operating system is accessed by the agent by making a function call to an operating system API. In other embodiments, the operating system automatically reports the information it gathered to the agent periodically. In other embodiments, the J2ME or dotnet extension to the operating system or custom extensions written by the manufacturer of the phone gathers the specific information needed and reports it to the agent or stores it and waits for a specific request from the agent. Information such as the carrier, plan code, identity of the employee, phone vendor, type, model and operating system type and revision and/or service pack number, incoming and outgoing call duration, phone location, phone numbers called, types of calls made such as data, voice, email or short messaging service, types of application programs that are loaded on the phone may be accessible in some embodiments through the agent program.

Typical information gathered from the cell service providers includes phone numbers of cell phones belonging to the enterprise serviced by each carrier and the calling plan details for each phone. Typical information gathered from the enterprise database(s) includes names of each employee who has been issued a phone, the cell phone number, the level of, the employee and the department in which the employee works.

The collection server gathers all the data and makes calculations of the type needed to create the various analysis figures and displays previously described and displays the resulting analysis on display 162. This information is useful to the enterprise, to cell service providers, phone manufacturers and 91 1/security/police functionaries and to advertisers.

In the prior art, phone manufacturers such as Motorola have obtained information from the database of carriers in xml files and on paper. However, nobody of which the applicants are aware has in the prior art gathered all the information detailed above from the cell phones, carriers and enterprise databases so that correlation of information from different sources can be used to do various forms of analysis.

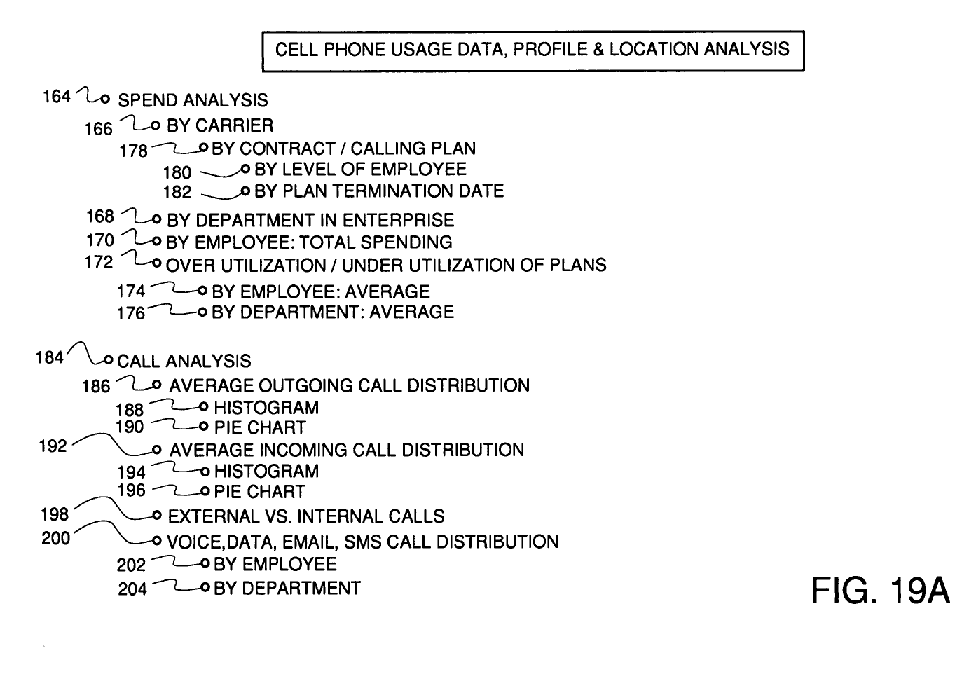

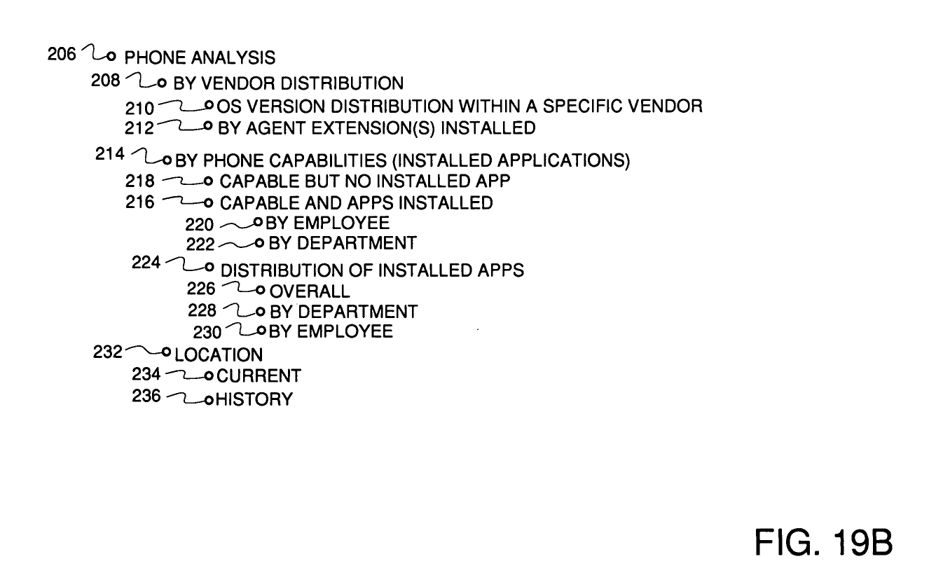

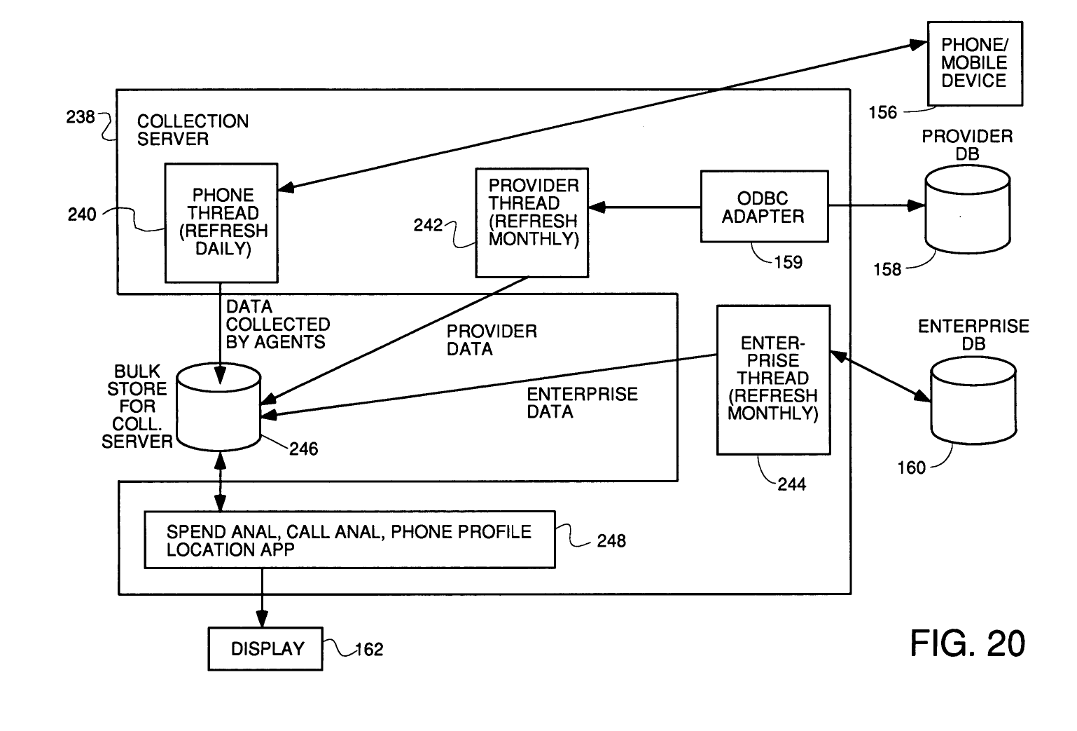

Typically, the collection server will have multiple data collection “threads” or processes which are simultaneously collecting data from the individual cell phones, the carrier databases and the enterprise databases. These threads can collect all the information the cell phone agents have gathered, and all the relevant information from the carrier and enterprise databases or, in alternative embodiments, they may just gather specified information from specific databases to do the particular analysis that has been requested by the user. In one embodiment, the analysis application is one big application that has access to all the data and provides a user interface such as is shown in FIG. 19 (comprised of FIGS. 19A and 19B) wherein the user can specify what type of analysis he wants. The format of the user interface display in the example of FIG. 19 is radio buttons, but in other embodiments, a menu bar with drop down menus for menu choices which have sub choices or other known types of interfaces may be used.

If the user wants spending analysis, he selects radio button. If she wants spending analysis by carrier, radio button 16 is selected. If he wants spending by department, radio button 168 is selected. If she wants total spending by employee to date, radio button 170 is selected. If the user wants to analyze average overutilization or underutilization of calling plans, radio button 172 is selected. If this overutilization or underutilization analysis is to be carried out on a per employee basis, radio button 174 is selected. If the overutilization or underutilization analysis is to be carried out on a per department basis, radio button 176 is selected. If the user wants to analyze spending on a per carrier basis to know the distribution of calling plans for a particular carrier, radio buttons 166 and 178 are selected. If the user wants to analyze spending on a per carrier basis to know the distribution of calling plans for a particular carrier by level of employee, radio buttons 166 and 178 and selected are selected. If the user wants to analyze spending on a per carrier basis to know the distribution of calling plans for a particular carrier by plan termination date distribution, radio buttons 166 and 178 and 182 are selected.

If the user wants to do call analysis, radio button 184 is selected. If the user wants to know average outgoing call duration distribution on a histogram format, radio buttons 184, 186 and 188 are selected. If the user wants to know average outgoing call duration distribution in a pie chart format, radio buttons 184, 186 and 190 are selected. If the user wants to know average incoming call duration distribution on a histogram format, radio buttons 184, 192 and 194 are selected. If the user wants to know average incoming call duration distribution on a pie chart format, radio buttons 184, 192 and 196 are selected. If the user wants to know the overall distribution of internal (inside the enterprise) calls versus external calls, radio button 198 is selected. If the user wants to know the overall distribution of voice, data, email and short messaging service calls, radio button 200 is selected. If the user wants to know the distribution of voice, data, email and short messaging service calls on a per employee basis, radio button 202 is selected. If the user wants to know the distribution of voice, data, email and short messaging service calls on a per department basis, radio button 204 is selected.

If the user wants to do phone profile analysis, radio button 206 is selected. If the user wants to know the distribution by vendor of the cell phones owned by the enterprise, radio button 208 is selected. If the user wants to know within a particular segment of phones provided by a particular vendor, the operating system version distribution, radio button 210 is selected. If the user wants to know which agent extensions are installed to obtain particular types of data from phones by a particular manufacturer, radio button 212 is selected. If the user wants to know the distribution of phone capabilities by applications that are installed in phones that are capable of carrying out particular functions (such as voice, data, SMS and email or web browsing capability), radio buttons 214 and 216 are selected. If the user wants to know the distribution of phone capabilities by applications that are installed on a per employee basis in phones that are capable of carrying out particular functions (such as voice, data, SMS and email or web browsing capability), radio buttons 214 and 216 and 220 are selected. If the user wants to know the distribution of phone capabilities by applications that are installed in phones that are capable of carrying out particular functions (such as voice, data, SMS and email or web browsing capability) on a per department basis, radio buttons 214 and 216 and 222 are selected. If the user wants to know the distribution of phones that are capable of performing particular functions but which do not have the applications installed to perform those functions, radio button 218 is selected. If the user wants to know the distribution of installed applications on an overall basis, radio buttons 224 and 226 are selected. If the user wants to know the distribution of installed applications on a per department basis, radio buttons 224 and 228 are selected. If the user wants to know the distribution of installed applications on a per employee basis, radio buttons 224 and 230 are selected.

If the user wants to know the current location of the phone, radio buttons 232 and 234 are selected. If the user wants to know the current location of the phone and the history of its prior locations, radio buttons 232 and 236 are selected.

The foregoing menu selections are exemplary only, and other embodiments incorporating menu selections for many other different kinds of analysis that may or may not be peculiar to a particular organization's needs also are within the teachings of the invention.

A schematic diagram of a generic architecture and process to collect the information from the phones, provider databases and enterprise databases is described in FIG. 19. The collection server 238 is programmed with a phone thread 240 which functions in accordance with any of the various embodiments described herein to gather data from the cell phones. Data collected from the cell phones is refreshed on a daily basis. A provider thread 242 controls the collection server to collect data from the provider databases 158 on a monthly basis. In some embodiments, an industry standard ODBC adapter process is used to control the collection server to interface with a database. For example, suppose that Nextel will send Excel spreadsheet files with the relevant data thereon. At configuration time, an adapter is configured to be able to open and understand the data format of Excel files and extract data therefrom and the directory is set indicating where the Excel file to be accessed can be found. An enterprise thread 244 controls the collection server to gather data from the enterprise databases 160 on a monthly basis. An adapter may also be set up to access the appropriate enterprise files, open them and access the relevant information The data collected from these three sources is stored in a repository 246 stored in a bulk storage memory or memory array. An analysis application 248 controls display to display some type of user interface display such as that shown in FIGS. 19A and 19B to receive user input regarding the desired analysis to be performed on the collected data, performs at least the requested analysis and displays results on display 162.

Data collected from the enterprise database and provider database can be gathered electronically by a scripted process over the internet if the provider and enterprise are willing to expose their database server's public IP address. For scripted electronic gathering of data, the system administrator of the computer system from which data will be collected provides the path information and file name of all files that need to be accessed, the application program that needs to be running to access the file and any IP address or other logon information needed for internet access or dial up connections and all protocol information needed to access the necessary files. All this information will be recorded in the script file for a script to be executed to access the necessary files and download the relevant information. In alternative embodiments, the requested data can be supplied via storage media such as zip drive, DVD-RAM, etc which is mailed to the collection server operators and imported into repository 246. In other embodiments, the provider and or enterprise may send paper records which are print outs from their databases and the operators of the collection server can enter the data by hand into repository 246.

### Embodiment 1

### Collection Server Just Gathers Data it Needs

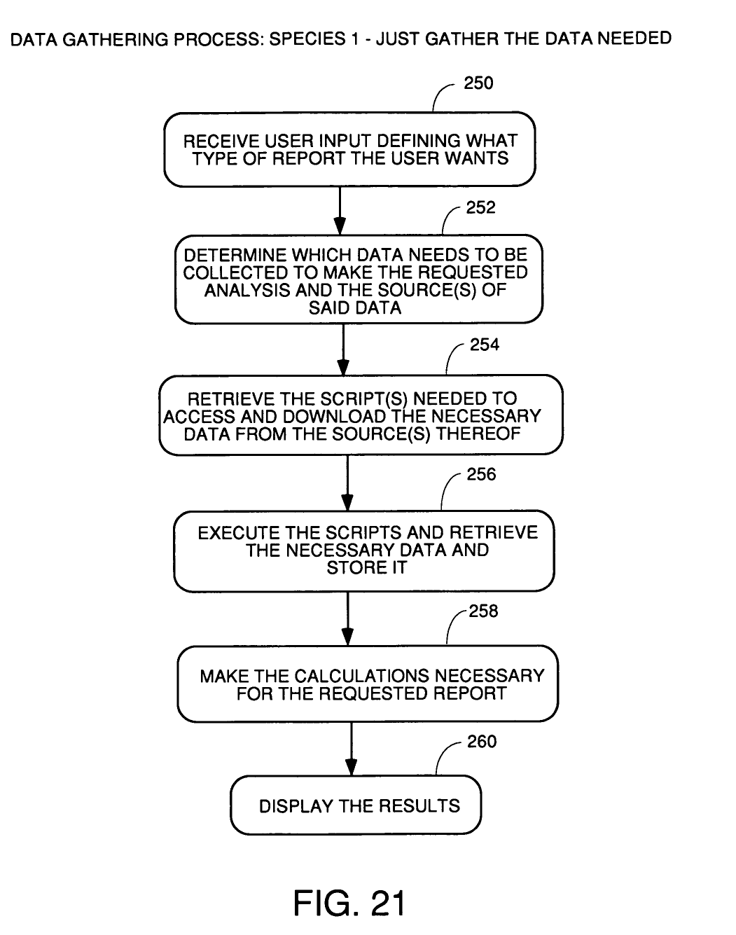

FIG. 21 is a flowchart of a process to determine what type of analysis the user wants and just retrieve the data needed to make the required report. In step 250, the collection server receives user input from a pointing device, keyboard, touchscreen etc. and a displayed user interface such as the one previously described. The user input defines which type of report the user wishes to see. In step 252, the collection server determines which data needs to be collected to make the requested analysis and source or sources of the data. In step 254, the collection server retrieves any necessary script or scripts to log onto the computer(s) upon which the file(s) to be accessed are stored. In step 256, the collection server executes the script(s) and retrieves the necessary data and stores it. In step 258, the collection server makes the calculations necessary for the requested report and displays the result in step 260.

### Embodiment 2

### Collection Server Gathers All Possible Data and Just Analyzes Data it Needs to Satisfy Request

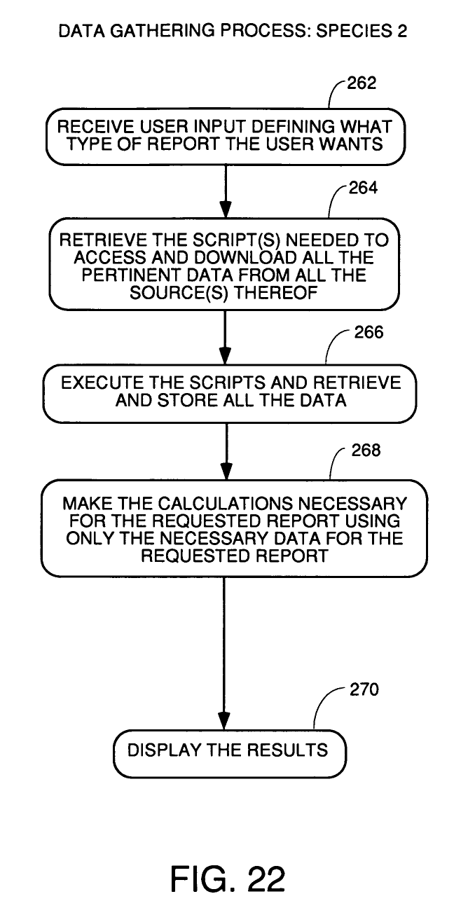

FIG. 22 is a flowchart of another embodiment wherein the collection server gathers all the possible data and then just analyzes the data necessary to satisfy the request. In step 262, user input defining what type of report the user wants is received. In step 264, the scripts necessary to retrieve all the different types of data which are available from the cell phones, cellular service provider databases and the enterprise databases are retrieved. In step 266, the scripts are executed and all the available data is retrieved and stored. In step 268, the collection server uses only the pertinent data for the requested report and makes the calculations necessary to generate the requested report and displays it in step 270.

### Embodiment 3

### Collection Server Gathers All Possible Data and Does All Forms of Analysis User Might Ask for and Just Displays Results in Which User is Interested

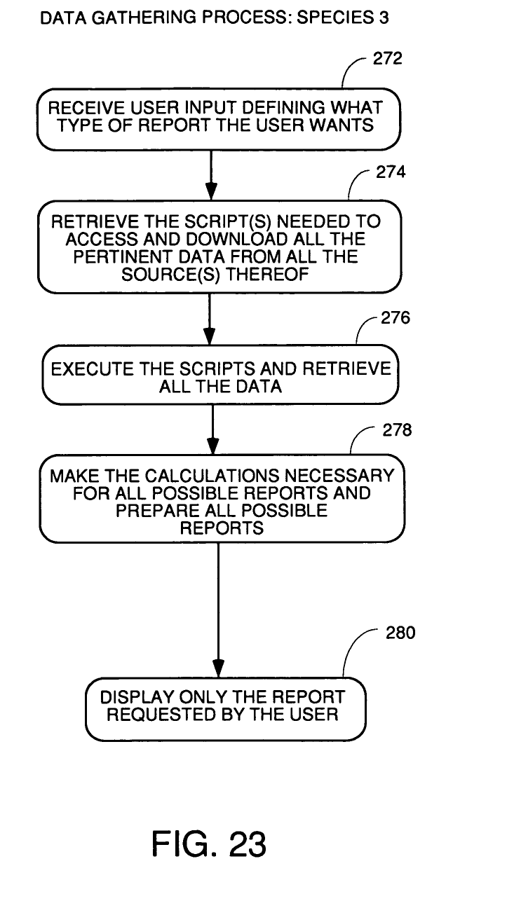

FIG. 23 is a flowchart of a third embodiment wherein all possible data is collected and all possible reports are calculated but only the report requested by the user is displayed. In step 272, the user input defining which type of report the user wants to see is received. In step 274, the collection server retrieves all the scripts necessary to retrieve all the possible data from all the possible sources. In step 276, the scripts are executed and the data is retrieved and stored. In step 278, the calculations necessary for each possible report the user can request are made using the freshly retrieved data, and all possible reports are prepared. In step 280, the collection server displays only the particular report requested by the user.

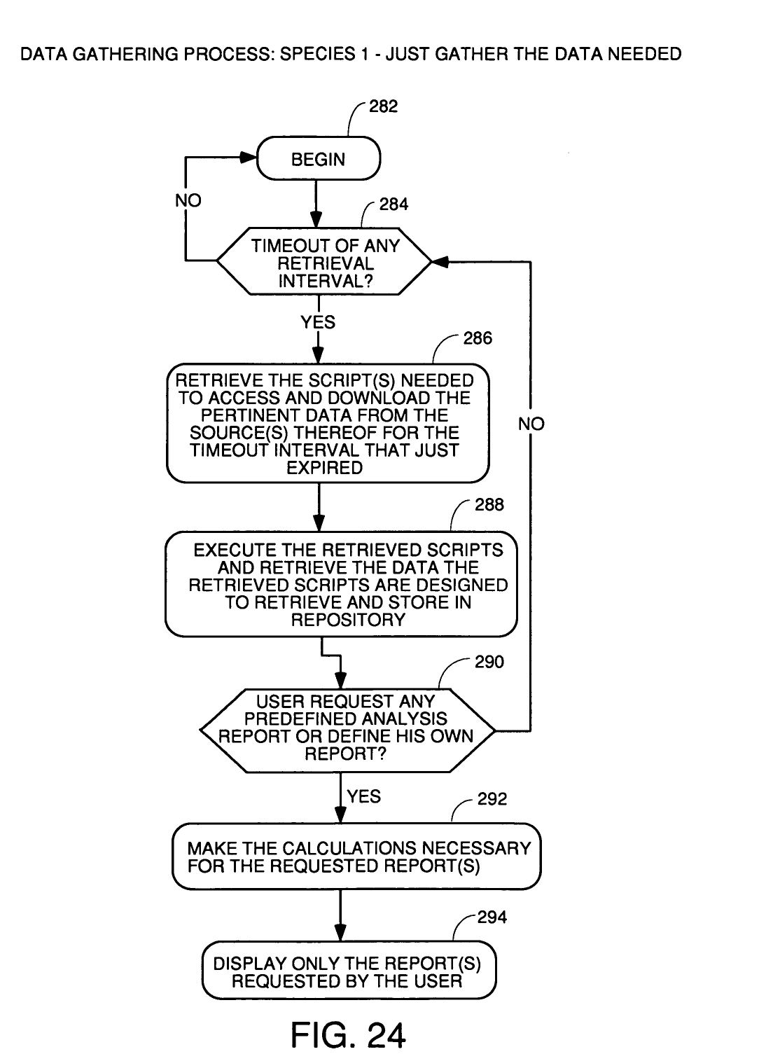

In alternative embodiments of the embodiments of FIGS. 21, 22 and 23, the collection server executes the process of FIG. 24. FIG. 24 is a flowchart of a process wherein all the data from all the sources is gathered on a periodic basis with a different interval for different types of data. The process begins in step 282 and transitions to test 284 where it is determined whether any retrieval interval is timed out. Typically the data from the cell phones is gathered at least daily or hourly in some cases since the phones have limited memory and call timer and other data accumulates fast on a daily basis. Data from the cell phone providers and the enterprise databases changes less frequently and can be configured to be gathered on a monthly or weekly basis. The timeout intervals may be fixed in some embodiments or configurable in other embodiments. Step 286 retrieves the script(s) needed to access and download the pertinent data from the source(s) thereof for the timeout interval that just that just expired.

Step 288 executes the retrieved scripts and retrieves the data the retrieved scripts are designed to retrieve and stores the retrieved data in a repository. Test 290 is then performed to determine if the user requested any predefined analysis report or defined her own analysis report and requested that it be run. If not, processing returns to step 284. If the user did request a predefined or custom report, step 292 is performed to make the calculations necessary for the requested report(s). In step 294, the requested report(s) are displayed.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A process for collecting and analyzing data of mobile device usage by an organization, comprising the steps:
1) determining in a collection server if any repetitive data retrieval interval for any particular type of data pertaining to the characteristics and/or usage of mobile devices such as cell phones has expired and it is time to retrieve the type of data associated with the expired data retrieval interval;
2) retrieving a script for each type of data to be retrieved, said script defining all the information and protocols needed to log onto a computer coupled to said collection server by a local area or wide area network and to retrieve the particular kind of data associated with the script stored on said computer;
3) executing said retrieved script or scripts on said collection server and retrieving each type of said data said script or scripts are designed to retrieve, and storing said retrieved data in a repository;
4) determining if a user of said collection server has requested any predefined analysis report to analyze said collected data in a particular way or has defined his own custom report to analyze said collected data in a particular way, and, if not, returning to step 1, and, if a predefined or custom report has been requested, proceeding to step 5;
5) accessing the data stored in said repository and performing calculation defined in said report; and
6) displaying the report or reports requested by said user using calculation results from step 5.

2. The process of claim 1 wherein steps 1, 2 and 3 are performed continuously in background.

3. The process of claim 1 wherein steps 1, 2 and 3 are performed continuously in background using a different thread process for each different source of data.

4. The process of claim 2 wherein steps 1, 2 and 3 are performed continuously in background using a thread process for executing a script controlling said collection server to collect data from cell phones and other mobile devices issued by an organization and using a different thread process controlling said collection server to collect data from one or more servers of a cell phone service provider, and using a different thread process controlling said collection server to collect data from one or more servers controlled by said organization which issued said cell phones and other mobile devices.

5. A collection server apparatus comprising:
a data input device;
a pointing device;
a display;
a computer programmed with an operating system and further programmed with one or more application or other programs which control said computer to perform the following steps:
1) determining in a collection server if any repetitive data retrieval interval for any particular type of data pertaining to the characteristics and/or usage of mobile devices such as cell phones has expired and it is time to retrieve the type of data associated with the expired data retrieval interval;
2) retrieving a script for each type of data to be retrieved, said script defining all the information and protocols needed to log onto a computer coupled to said collection server by a local area or wide area network and to retrieve the particular kind of data associated with the script stored on said computer;
3) executing said retrieved script or scripts on said collection server and retrieving each type of said data said script or scripts are designed to retrieve, and storing said retrieved data in a repository;
4) determining if a user of said collection server has requested any predefined analysis report to analyze said collected data in a particular way or has defined his own custom report to analyze said collected data in a particular way, and, if not, returning to step 1, and, if a predefined or custom report has been requested, proceeding to step 5;
5) accessing the data stored in said repository and performing calculation defined in said report; and
6) displaying the report or reports requested by said user using calculation results from step 5.

6. The apparatus of claim 5 wherein said computer is further programmed with a program that causes it to perform steps 1, 2 and 3 continuously in background using a different thread process for each different source of data.

7. The apparatus of claim 5 wherein said computer is further programmed with a program that causes it to perform steps 1, 2 and 3 continuously in background using a thread process for executing a script controlling said collection server to collect data from cell phones and other mobile devices issued by an organization and using a different thread process controlling said computer to collect data from one or more servers of a cell phone service provider, and using a different thread process controlling said computer to collect data from one or more servers controlled by said organization which issued said cell phones and other mobile devices.

8. A process comprising the steps:
receiving user input on a collection server, said user input defining what type of report or reports a user desires to analyze characteristics and usage of a population of cell phones and/or other mobile devices supplied by an organization to its employees;
determining from the type of report requested, what type of data will be needed to make the analysis requested;
retrieving a script associated with each type of data needed, each script defining all the information and protocols needed to log onto a computer which stores the needed data and retrieve said data;
executing said script or scripts and collecting the needed data and storing said data in a repository;
accessing said data in said repository and making calculations thereon as defined in said requested report or reports; and
displaying the results of said calculations in a format or formats defined by said requested report or reports.

9. A process comprising the steps:
receiving user input on a collection server, said user input defining what type of report or reports a user desires to analyze characteristics and usage of a population of cell phones and/or other mobile devices supplied by an organization to its employees;
retrieving a script associated with each type of data which is available from sources of cell phone and/or mobile device data, each script defining all the information and protocols needed to log onto a computer which stores a particular type of data and retrieve said data;
executing said script or scripts and collecting all said data pertaining to cell phones or mobile devices supplied by an organization to its employees and storing said data in a repository;
accessing only said data in said repository needed to make the calculation defined in said requested report or reports, and making calculations thereon as defined in said requested report or reports; and
displaying the results of said calculations in a format or formats defined by said requested report or reports.

10. A process comprising the steps:
receiving user input on a collection server, said user input defining what type of report or reports a user desires to analyze characteristics and usage of a population of cell phones and/or other mobile devices supplied by an organization to its employees;
retrieving a script associated with each type of data which is available from sources of cell phone and/or mobile device data, each script defining all the information and protocols needed to log onto a computer which stores a particular type of data and retrieve said data;
executing said script or scripts and collecting all said data pertaining to cell phones or mobile devices supplied by an organization to its employees and storing said data in a repository;
accessing said data in said repository, and making calculations thereon as defined in all possible predefined reports which a user could ask for; and
displaying the results of only those calculations defined by the report or reports requested by a user in a format or formats defined by said requested report or reports.

11. A collection server apparatus comprising:
a data input device;
a pointing device;
a display;
a computer programmed with an operating system and further programmed with one or more application or other programs which control said computer to gather and store data regarding the characteristics and usage of a population of cell phones and/or other mobile devices supplied by an organization to its employees and to make calculations on said data in accordance with one or more predefined or custom designed reports which have been requested by a user.

12. The apparatus of claim 11 wherein said one or more application or other programs control said computer to perform the following steps:
receiving user input on a collection server, said user input defining what type of report or reports a user desires to analyze characteristics and usage of a population of cell phones and/or other mobile devices supplied by an organization to its employees;
determining from the type of report requested, what type of data will be needed to make the analysis requested;
retrieving a script associated with each type of data needed, each script defining all the information and protocols needed to log onto a computer which stores the needed data and retrieve said data;
executing said script or scripts and collecting the needed data and storing said data in a repository;
accessing said data in said repository and making calculations thereon as defined in said requested report or reports; and
displaying the results of said calculations in a format or formats defined by said requested report or reports.

13. The apparatus of claim 11 wherein said one or more application or other programs control said computer to perform the following steps:
receiving user input on a collection server, said user input defining what type of report or reports a user desires to analyze characteristics and usage of a population of cell phones and/or other mobile devices supplied by an organization to its employees;
retrieving a script associated with each type of data which is available from sources of cell phone and/or mobile device data, each script defining all the information and protocols needed to log onto a computer which stores a particular type of data and retrieve said data;
executing said script or scripts and collecting all said data pertaining to cell phones or mobile devices supplied by an organization to its employees and storing said data in a repository;
accessing only said data in said repository needed to make the calculation defined in said requested report or reports, and making calculations thereon as defined in said requested report or reports; and
displaying the results of said calculations in a format or formats defined by said requested report or reports.

14. The apparatus of claim 11 wherein said one or more application or other programs control said computer to perform the following steps:
receiving user input on a collection server, said user input defining what type of report or reports a user desires to analyze characteristics and usage of a population of cell phones and/or other mobile devices supplied by an organization to its employees;
retrieving a script associated with each type of data which is available from sources of cell phone and/or mobile device data, each script defining all the information and protocols needed to log onto a computer which stores a particular type of data and retrieve said data;
executing said script or scripts and collecting all said data pertaining to cell phones or mobile devices supplied by an organization to its employees and storing said data in a repository;
accessing said data in said repository, and making calculations thereon as defined in all possible predefined reports which a user could ask for; and
displaying the results of only those calculations defined by the report or reports requested by a user in a format or formats defined by said requested report or reports.

15. A computer-readable medium having stored thereon computer executable instructions which control a collection server to perform the following process:
1) determining in said collection server if any repetitive data retrieval interval for any particular type of data pertaining to the characteristics and/or usage of mobile devices such as cell phones has expired and it is time to retrieve the type of data associated with the expired data retrieval interval;
2) retrieving a script for each type of data to be retrieved, said script defining all the information and protocols needed to log onto a computer coupled to said collection server by a local area or wide area network and to retrieve the particular kind of data associated with the script stored on said computer;
3) executing said retrieved script or scripts on said collection server and retrieving each type of said data said script or scripts are designed to retrieve, and storing said retrieved data in a repository;
4) determining if a user of said collection server has requested any predefined analysis report to analyze said collected data in a particular way or has defined his own custom report to analyze said collected data in a particular way, and, if not, returning to step 1, and, if a predefined or custom report has been requested, proceeding to step 5;
5) accessing the data stored in said repository and performing calculation defined in said report; and
6) displaying the report or reports requested by said user using calculation results from step 5.

16. A computer-readable medium having stored thereon computer executable instructions which control a collection server to perform the following process:
receiving user input on a collection server, said user input defining what type of report or reports a user desires to analyze characteristics and usage of a population of cell phones and/or other mobile devices supplied by an organization to its employees;
determining from the type of report requested, what type of data will be needed to make the analysis requested;
retrieving a script associated with each type of data needed, each script defining all the information and protocols needed to log onto a computer which stores the needed data and retrieve said data;
executing said script or scripts and collecting the needed data and storing said data in a repository;
accessing said data in said repository and making calculations thereon as defined in said requested report or reports; and
displaying the results of said calculations in a format or formats defined by said requested report or reports.

17. A process for providing a user interface for interacting with a computer to enable analysis of the characteristics and usage of a population of cell phones and other mobile devices provided by an organization to its employees, comprising the steps:
providing one or more menu choices which enable a user to invoke one or more processes to do phone analysis;
providing one or more menu choices which enable a user to invoke one or more processes to do call analysis;
providing one or more menu choices which enable a user to invoke one or more processes to do spending analysis;
responding to invocation of one or more of said processes by said user by launching the appropriate process or processes and doing the requested analysis of data defining the characteristics and usage of cell phones and mobile devices provided by an organization to its employees; and
displaying the results of said analysis.

18. The process of claim 17 wherein said analysis of data is performed on data collected from cell phones and other mobile devices, cell phone service providers and servers operated by an organization that provided cell phones or other mobil devices to its employees.

19. The process of claim 18 wherein said data is collected using one or more scripts that define the computers on which the desired data is stored, the log on procedures for said computers, the location or locations on said computer where the desired data is stored and all protocols or other information needed to access the data and download it to a collection server where said analysis is performed.
